(19) United States
(12) Patent Application Publication
(10) Pub. No.: US 2013/0254896 A1
(43) Pub. Date: Sep. 26, 2013

(54) Method to Detect Tampering of Data

(71) Applicants: Juergen Helmschmidt, Gilching (DE); Fabio Parodi, Genova (IT); Stephan Schoenfeldt, Hoehenkirchen-Siegertsbrunn (DE); Sergio Rossi, Genoa (IT)

(72) Inventors: Juergen Helmschmidt, Gilching (DE); Fabio Parodi, Genova (IT); Stephan Schoenfeldt, Hoehenkirchen-Siegertsbrunn (DE); Sergio Rossi, Genoa (IT)

(73) Assignee: INFINEON TECHNOLOGIES AUSTRIA AG, Villach (AT)

(21) Appl. No.: 13/459,772

(22) Filed: Apr. 30, 2012

Related U.S. Application Data
(63) Continuation-in-part of application No. 13/428,718, filed on Mar. 23, 2012.

(51) Int. Cl. G06F 21/24

(52) U.S. Cl. 726/26

(57) ABSTRACT

A method to detect tampering includes constant acquiring of measurement raw data in a sensor unit; processing of measurement raw data of a defined time interval in a metrology unit, obtaining first measurement results; at least one of storing of the first measurement results and transmitting of the first measurement results to an authority at defined time instances via a communication channel; at least one of storing of a defined fraction of measurement raw data and transmitting of a defined fraction of measurement raw data to the authority in a random manner via the communication channel; processing of the measurement raw data of the defined time interval at the authority, obtaining second measurement results; and comparing the first and second measurement results of a time interval.

This application is a continuation in part of U.S. patent application Ser. No. 13/428,718, entitled “Method to Detect Tampering of Data,” filed on Mar. 23, 2012, which is incorporated herein by reference.

### TECHNICAL FIELD

The present invention relates to a method for detecting tampering of data, especially of measurement data in metering applications.

### BACKGROUND

Automatic meter reading (AMR) has been introduced by utility providers, like energy or gas providers for example, in order to be able to automatically collect consumption, diagnostic and status data from energy or water metering devices. These data are transferred to a central database for billing, troubleshooting and analyzing. This makes information about consumption available almost real-time. This timely information coupled with analysis may help both utility providers and consumers to better control the use and production of electric energy, gas usage or water consumption.

Originally, AMR devices only used to collect meter readings electronically and to match them with accounts. As technology has advanced, additional data may now be captured, stored, and transmitted to the main computer located at the utility providers, and the metering devices may be controlled remotely. Many AMR devices can also capture interval data, and log meter events.

The logged data can be used to collect or control time of use or rate of use data that can be used for water or energy usage profiling, demand forecasting, demand response, flow monitoring, water and energy conservation enforcement, remote shutoff, and many more.

Advanced Metering Infrastructure (AMI) is the new term introduced to represent the two way communication technology of fixed network meter systems that go beyond AMR into remote utility management. The meters in an AMI system are often referred to as smart meters, since they can include programmable logic.

A smart meter device is usually an electronic device which is coupled to the power line and which is adapted to measure the voltage and current of the power line. Data representing the voltage and current of the power line can be processed, in order to determine a power consumption, for example. Instead of a power line, smart meters might as well be coupled to gas, water or heating lines, for example, and measure and store a respective consumption. A memory of the smart meter holding the consumption data can be read out on-site. Alternatively, the smart meter may have an interface which connects the smart meter to a communication network. Via the network the utility provider can read out the memory so that there is no need to have an employee on-site. The user and the utility provider, for example, are then able to access this data at any time. The user often is able to read out at least a basic set of data, like a total consumption, the consumption of the day or the current consumption, for example, at any time. The smart meter therefore may include a display, like an LCD display, for example, or any kind of interface that is suited for remote read out of data, like a personal computer or laptop, for example. Transmission of the data to the read out device can be done via an interface like universal serial bus (USB), wireless local area network (WLAN) or RS232, for example. The results of the measurements are generally sent to an authority, the electric power supplier, for example, via a remote channel. Usually aggregated measurement results, like the measured total energy delivered to the household, is frequently sent to the authority.

The meter itself therefore fulfills several tasks. First, it acquires the measurement data. It generally receives the measured data values from sensors, like electricity shunts, current coils or Hall sensors, for example, in case of power lines. These values are digitized using analog to digital converters (ADCs). Second, the meter processes the measurement data, which is generally called “raw data,” into aggregated data. A set of raw data usually represents one measurement point in time.

Usually sampling rates vary in terms of kHz (e.g. 2, 4, 8, 16 kHz). Aggregated data typically represents the consumed amount of energy, as well as the type and time of power and energy supply. This processed, aggregated data can be sent to a central authority for billing, for example.

As the data transmitted to the authority is used for billing, it might be manipulated by the users, in order to represent a lower consumption to the supplier to reduce the users costs. Therefore the metering device has to be strongly protected against tampering, especially against sending of wrong data, representing a too low consumption. In known metering applications, processed data which is sent to the authorities, normally is signed, using hash values of a metrology CPU (central processing unit) code which is generally used and which is executed in a microcontroller or a processor of the metering device, for example.

On the other hand, data might be tampered by the supplier, in order to be able to bill a higher amount. In this case, the meter usually reports values that are too high, compared to the real consumption of the user. In case of a tampering attack by the user, it is the suppliers interest, to unravel the tampering approach. In case of a tampering attack by the supplier, there needs to be a way for the customer, to verify that the billed amount of consumption is correct and really represents his consumption.

A problem is, that known solutions still allow tampering. For example, the metrology application software might be exchanged against a “user friendly” or a “supplier friendly” software, delivering lower or higher aggregated results to the authority. Two common methods of tampering are to either exchange the metrology application code or to exchange the acquired data against “user friendly” or “supplier friendly” data in the data transmission/sending process from the meter to the authority. By exchanging acquired data against user friendly data, the metrology application is kept untouched, but wrong data is sent to the authority instead of the real acquired and/or processed data. This may also include wrong calibration of the acquired raw data. Calibration in this context meaning the translation of ADC output data of a given bit size into real voltage or current data, representing the consumption.

A solution is needed, to better protect metering applications against tampering attacks.

### SUMMARY OF THE INVENTION

A method to detect tampering of data is disclosed. In accordance with one example of the present invention, the method comprises: constant acquiring of measurement raw data in a sensor unit; processing of measurement raw data of a defined time interval in a metrology unit, obtaining first measurement results; storing of the first measurement results or transmitting of the first measurement results to an authority at defined time instances via a communication channel; storing of a defined fraction of measurement raw data or transmitting of a defined fraction of measurement raw data to the authority in a random manner via the communication channel; processing of the measurement raw data of the defined time interval at the authority, obtaining second measurement results; and comparing the first and second measurement results of a time interval.

Further, a smart meter is disclosed. In accordance with one example of the present invention, the smart meter comprises: a sensor unit, which is configured to measure one or more parameters of interest and provide measurement raw data, representing the parameters of interest; and a metrology unit, which is configured to receive the measurement raw data from the sensor unit, to at least one of store and transmit a defined fraction of measurement raw data of a defined time interval in a random manner via a communication channel, to process measurement raw data of the defined time interval, obtaining first measurement results, and to at least one of store and transmit the first measurement results via the communication channel; the smart meter is configured to be coupled to an authority via the communication channel, the authority being configured to receive the first measurement results, receive and process the defined fraction of measurement raw data of the defined time interval, obtaining second measurement results, and compare the first and second measurement results of a time interval.

Further, a system to prevent tampering of data is disclosed. In accordance with one example of the present invention, the system comprises: a smart meter, which comprises a sensor unit, which is configured to measure one or more parameters of interest and provide measurement raw data, representing the parameters of interest; and a metrology unit, which is configured to receive the measurement raw data from the sensor unit, at least one of store and transmit a defined fraction of measurement raw data of a defined time interval in a random manner via a communication channel, process measurement raw data of the defined time interval, obtaining first measurement results, and at least one of store and transmit the first measurement results via the communication channel; and an authority, which is coupled to the smart meter via the communication channel, the authority being configured to receive and process the defined fraction of measurement raw data of the defined time interval, obtaining second measurement results, receive the first measurement results and compare the first and second measurement results of a time interval.

### BRIEF DESCRIPTION OF THE DRAWINGS

Examples will now be explained with reference to the drawings. The drawings serve to illustrate the basic principle, so that only aspects necessary for understanding the basic principle are illustrated. The drawings are not to scale. In the drawings the same reference characters denote like features.

FIG. 1 illustrates a block diagram of a smart meter device;

FIG. 2 illustrates a more detailed block diagram of a smart meter device;

FIG. 3 shows illustrating timing diagrams of a possible power consumption of a household and a tampered power supply characteristic;

FIG. 4 illustrates a block diagram of a tamper proof smart meter device;

FIG. 5 illustrates a block diagram of the smart meter device of FIG. 4 in more detail; and

FIG. 6 illustrates an example of a data array.

### DETAILED DESCRIPTION OF ILLUSTRATIVE EMBODIMENTS

In the following detailed description, reference is made to the accompanying drawings, which form a part thereof, and in which is shown by way of illustration specific embodiments in which the invention may be practiced. In this regard, directional terminology, such as “top,” “bottom,” “front,” “back,” “leading,” “trailing” etc., is used with reference to the orientation of the Figures being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that the features of the various exemplary embodiments described herein may be combined with each other, unless specifically noted otherwise.

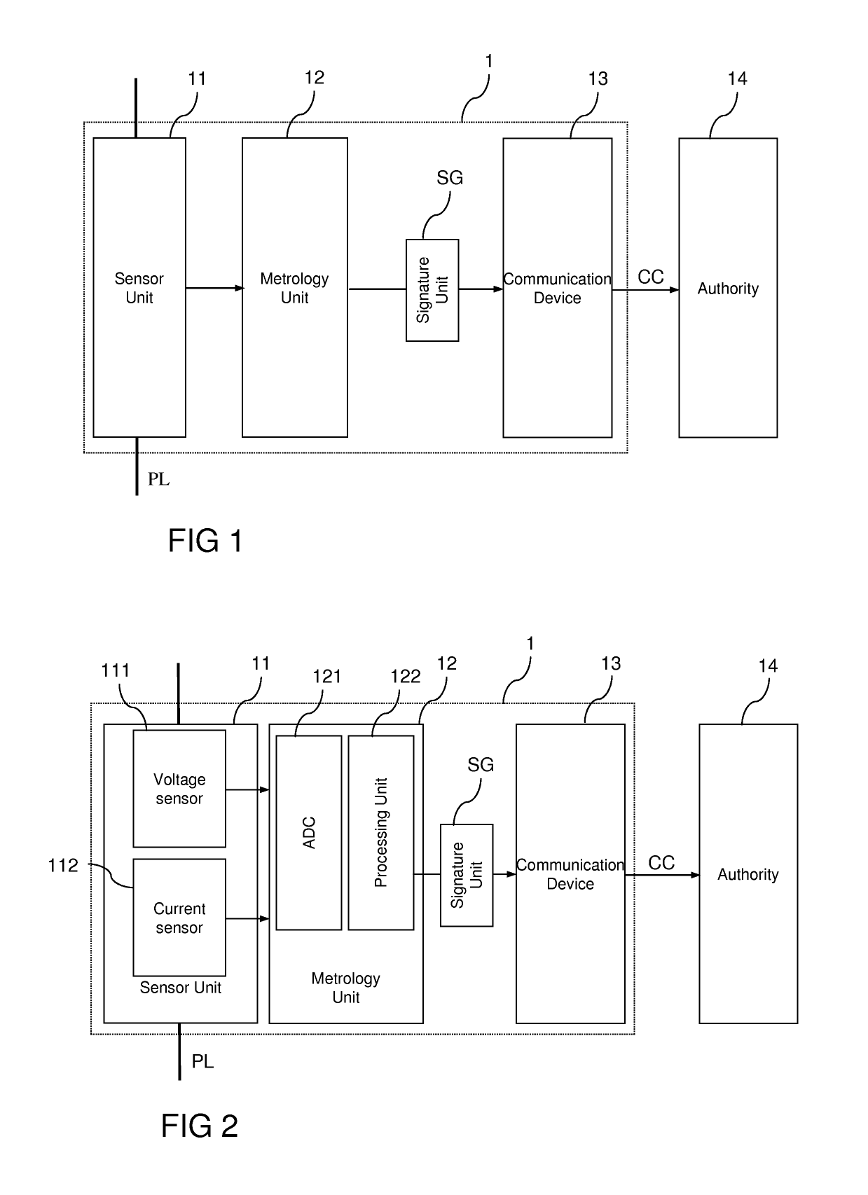

In FIG. 1 a block diagram of a smart meter device 1 is shown. A smart meter device 1 is generally coupled to a supply line, such as a power line PL or a gas, water or heating line. In order to measure the relevant data, a sensor unit 11, which is part of the smart meter, is connected to the power line PL. The sensor unit 11 can measure one or more parameters of interest and provide data representing the measured parameters. If the supply line is a power line PL, a current through the power line and a voltage between the power line and a reference potential, such as ground, are normally the main parameters of interest, in order to be able to calculate the power consumption of loads, which are coupled to the power line PL.

The smart meter 1 can further include a metrology unit 12, for example, which is coupled to the sensor unit 11. The metrology unit 12 receives the measurement data, often called raw data, from the sensor unit 11 and further processes this raw data. Raw data in this context refers to data, that has not yet been modified by any software algorithm or any hardware circuit (e.g. in terms of digital signal processing) which is meant to process raw data in order to receive any kind of aggregated data. Processing may also include methods of calibration, e.g., translation of raw data of a defined bit size into any other kind of data that shows a direct relation to physical parameters like voltage (measured in Volt), current (measured in Ampere), gas or water flow (measured in m³), for example. The metrology unit 12 can perform the necessary calculation of the power consumption. The metrology unit 12 may include a storage device (not shown) to store the processed data, as well as a temporary set of raw data or intermediate processing results of a metrology algorithm, for example.

The processed data can be sent to a central authority 14 for billing, for example. As this data might be tampered, it is normally signed and/or encrypted. Therefore, the smart meter 1 includes a signature unit SG which is coupled to the metrology unit 12. Data is often signed using hash values and/or encrypted using symmetric or asymmetric cryptographic algorithms like the advanced encryption standard (AES), the RSA algorithm or the elliptic curve cryptography (ECC) method, for example. These are well known methods for signing and encryption and are therefore not explained in detail. Several other signing and encryption methods are known, in order to protect the data. The signed data can then be sent to the authority 14, using a communication device 13, for example. The communication device 13 can be connected to the authority 14 through a communication channel CC, the communication channel CC being any kind of suitable wired or wireless channel. In some cases, the power line PL itself might function as communication channel CC, for example.

FIG. 2 illustrates the smart meter device 1 of FIG. 1 in greater detail. The sensor unit 11 may include a voltage sensor 111 and/or a current sensor 112, for example. It may as well include any other or additional kind of sensor, in order to measure the relevant parameters. Therefore, the kind of sensors used, strongly depends on the application and the typical parameters.

The metrology unit 12 may include analog-to-digital converters (ADCs) 121, for example. As the measurement data acquired by the sensor unit 11 is available as analog data, it is converted into digital data by the ADCs 121. The metrology unit 12 may include only one, or more than one ADC 121, one for each sensor 111, 112, for example. The digitized signal can then be processed and/or stored in a processing unit 122, for example.

The processing unit 122 is included in the metrology unit 12 and is coupled to the ADC 121. After having been processed within the processing unit 122, the data can be signed and/or encrypted. The signature unit SG is coupled to the processing unit 122, and is configured to sign and/or encrypt the data for secure communication. The signature unit SG can be reserved for exclusive access through the metrology code (firmware) or can be shared with other applications that may run on the device. To protect the signature unit SG of reconfiguration through malware application code, e.g., code which is not task of the metrology, the signature unit may be accessible via a process interface only, exclusively controlled by the metrology process.

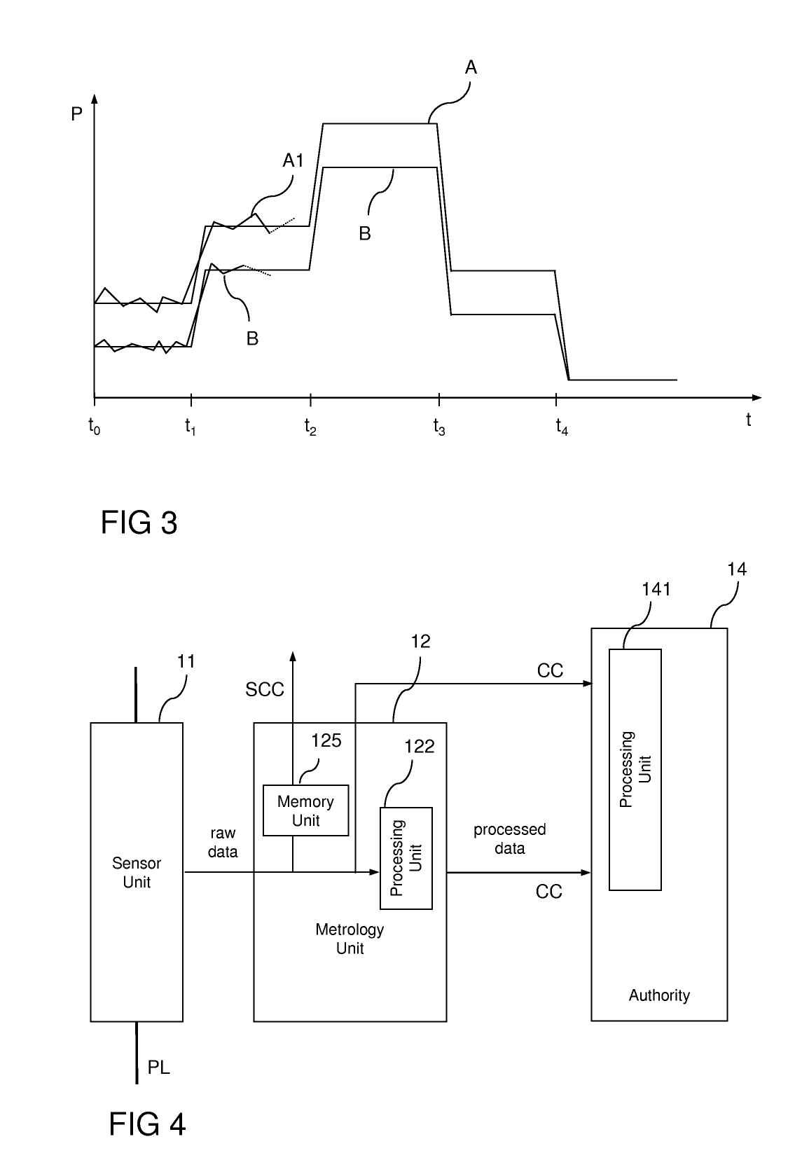

FIG. 3 shows an example of a possible power consumption of a household. The time t is shown on the x-axis and the power consumption P is shown on the y-axis. During a first time interval (from t₀ to t₁₎, the power consumption is relatively low. This could, e.g., represent a time, when the user just returned home from work and only some lights in the house are active. During a second time interval (from t₁ to t₂₎, the power consumption rises at a time instant t₁, because, e.g., other electronic devices like a dish washer, for example, might be active as well. At a later time instant t₂ even more electronic devices are activated, so that the consumption further increases. The user may be watching TV, while the dish washer is still running.

At a time instant t₃, the power consumption decreases to a lower level. In the given example, the dishwasher may be finished, while the TV is still running. At time instant t₄, the power consumption decreases to an even lower level. The user may have gone to bed, with only a few devices being in a standby mode and consuming a small amount of power.

The examples that are used to explain the charts are just very rough examples in order to illustrate the basic concept. In reality a dish washer, for example, generally does not have one stable phase over the whole duration of one washing cycle. It rather has several sub-phases such as heating phases or phases in which the pumps and motors are on or off. Most other electrical devices have several sub-phases as well.

A first chart A in the diagram shows the real power consumption. A second chart B shows a visibly lower power consumption. The second chart B represents tampered data. When manipulating the measurement data in such a way, the user would get billed a lower amount, compared to his real consumption. If the user managed to send such wrong data as represented by chart B, the energy provider would not know that data has been tampered, as he will only see the tampered consumption B. In case of a tampering attack of the supplier, chart B may be the real power consumption and chart A the tampered consumption.

However, the power consumption shown in charts A and B is only an approximated consumption. As is indicated by the additional charts A1 and B1, the consumption in reality is not constant. It can, however, be approximated to the consumption shown in charts A and B, which show a constant power consumption within each time interval.

It is desirable for the energy provider to detect, whether the data transmitted to the authority 14 is the correct data A or tampered data B. The same applies for the user. In order to be able to detect tampered data B, two types of data are sent to the authority 14: processed data in a usual way; and raw data. By sending raw data to the authority 14, recalculations of the consumption can be done and be compared to the transmitted consumption. In order to be able to discover a tampering attack of the supplier, the authority may not be the supplier itself, but an “official” independent authority, such as the government or someone who is authorized by the government, for example.

A block diagram of a smart meter 1, that is capable of supporting a secure (tamper proof) transmission of consumption data, is shown in FIG. 4. Like a conventional smart meter, the smart meter 1 includes a sensor unit 11, which is coupled to the power line PL. The sensor unit 11 can also include the sensors that are necessary to measure the parameters of interest. The sensor unit 11 provides the raw measurement data to the metrology unit 12. The raw data can be processed within the processing unit 122, which is included in the metrology unit. Before being processed, the raw data can also be transmitted from the metrology unit 12 to the authority 14 via a communication channel CC. The communication channel CC that is used for transmission may again be any kind of suitable wired or wireless channel.

Instead of directly transferring the raw data to the authority 14, the raw data may be stored in a memory unit 125. It is also possible to both transfer and store raw data, for example. Via a serial communication channel SCC, for example, the raw data may then be read out of the memory unit 125. The serial communication channel SCC may be a serial port like a UART connector (universal asynchronous receiver transmitter connector) or an IrDA (Infrared data association), for example. In some embodiments, however, the serial communication channel may be any other suitable channel which allows download of the stored data out of the memory. The serial communication channel SCC may be configured in such a way, that only authorized persons are allowed to download the stored data.

The raw data that is directly sent to the authority 14, may be sent out of the memory unit 125 or out of a not changeable memory, like a ROM, for example. In one embodiment of the present invention, there is no possibility to change or manipulate the raw data. In one embodiment of the present invention the raw data is not stored in any way, before being sent to the authority 14.

In order to keep the bandwidth limited, not all raw data is sent to the authority 14. However, enough data needs to be sent, to be able to detect tampering. For example, 1% or less of all raw data can be sufficient for the authority 14 to redo a calculation exact enough to detect tampering attacks, even if it is not possible to redo the exact metrology data processing algorithms.

The raw data are sent to the authority 14 in a controller random fashion, meaning that a random sample is chosen by a method involving an unpredictable component. Depending on a random number, in the long run a small portion like, e.g., 1%, or in general the given target data rate, is sent to the authority 14. Due to the random sending of data, assuming a constant power consumption during each phase (e.g. phases t₀ to t₁, t₁ to t₂, t₂ to t₃, t₃ to t₄), enough data are sent to reconstruct the averaged power consumption within each phase. Such a smart meter may form a low pass filter. Fast changes in the consumption cannot be seen, but in general, this is not necessary for the purpose of detecting tampering attacks. Data normally represents sine waves. In order to be able to calculate the most important data, like a root mean square of the power, for example, the basic sine wave should be known, at least approximately. The sine wave of one cycle of raw data normally consists of about 80 to about 160 samples. By transmitting 1% of raw data, on average about 1 to 2 samples of each cycle of raw data will be transmitted. This means, that about 100 cycles or, at a line frequency of 50 Hz, 2 seconds would be needed to get one full approximated sine wave.

Using the method explained before, it is not possible to prevent random samples from being sent. Random values are used for the decision whether a given sample is to be sent, because it is not allowed to store or use any volatile data and each sending preferably does not depend on any of the preceding data transmissions. Raw data will normally be packed and sent immediately after sample acquisition. There may be n acquisition time points per second, for example, depending on the given sampling rate of the ADC that is used. Because this basic sending of raw data from the ADC to the communication device 13 cannot be interrupted, it is not possible to prevent any samples from being sent.

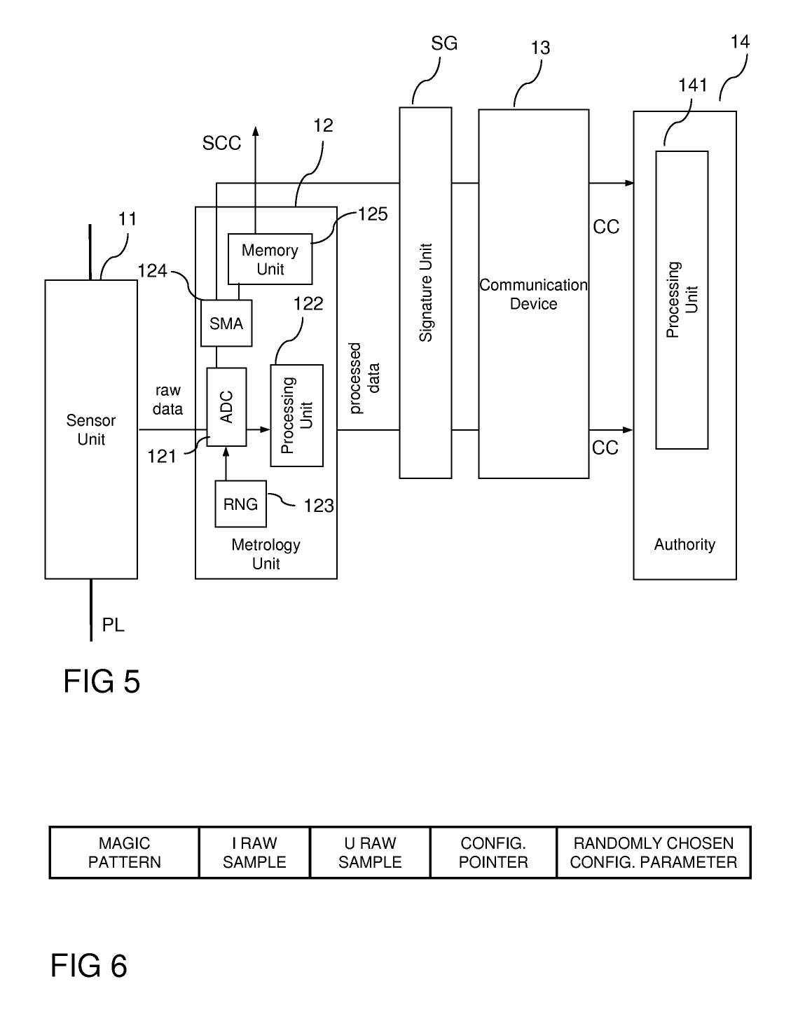

The metrology unit 12 may also include ADCs 121 in order to digitize the analog measurement data, before being sent, stored or processed. Raw data can be acquired directly at the analogue to digital converter 121. At this point the data has only been processed by hardware, but was not processed or modified by any software algorithm yet. Depending on a random number, provided by a random number generator 123, for example, which can be implemented in hardware, e.g. digital logic, it is decided whether the raw data are to be sent to the authority 14. A smart meter 1, like the one shown in FIG. 4, but which further includes an analogue to digital converter 121, as well as a random number generator 123 is shown in FIG. 5. The smart meter may further include a secured memory area 124, in which raw data may be temporarily stored. The secured memory area 124 may be any kind of (nonvolatile) memory which cannot be read by everybody, like some kind of flash memory, for example.

The raw data is generally first signed and/or encrypted in a signature unit SG, before being sent to the authority 14, as well as the processed data. For signature, the same or different encryption methods might be used for raw data and for processed data. For transmitting the raw and the processed data, a communication device 13 might be used, just as in known smart meter devices. In some embodiments it may be possible, to run the signature unit SG in a privileged mode, when raw data is encrypted. The signature unit SG may be, for example, reserved for exclusive access through a privileged CPU mode (central processing unit mode).

In order to send the raw data to the authority 14, the data are packed into arrays directly at the hardware output. An example of such an array is shown in FIG. 6. An array may include one sample of every measurement point, for example a raw data sample of a current I RAW SAMPLE, and a raw data sample of a voltage U RAW SAMPLE. In an electricity meter this may be one voltage value as well as several current values coded as integer, signed integer or floating point values of a given amount of bits. Usually 8, 16, 24 or 32 bits per value are used, but other amounts of bits are also possible.

The signal paths from the sensor unit 11 to the ADCs 121 may have a different length. The voltage and current values that are sent together within one array, may therefore refer to different measurement time points. As this characteristic stays constant over time and is characteristical for each system, it is known to the authority. In order to handle the time difference between two values within one array, the voltage values may be used to interpolate a voltage waveform, for example. From the value distribution over time, even some harmonics might be reconstructed, for example. When a sample pair of voltage and current is received, the authority may determine the position on the interpolated voltage, using the actual voltage sample. Finally, the current sample may be multiplied with the value on the interpolated voltage wave, considering a certain known delay.

The array may also include a “MAGIC PATTERN,” which is a special code word of a fixed value. When the authority 14 receives an array which includes a magic pattern, it will identify this array as a raw data array. In that way, processed data arrays can be distinguished from raw data arrays.

The array can further include a randomly chosen internal configuration value of the meter. An exact calculation is usually depending on the configuration and calibration of the metering device. In order to allow the authority 14 to redo exact calculations, with each array one randomly chosen configuration value can be provided, for example. On the long run, the authority 14 will then receive the complete configuration of the device. Configuration values can include gain amplifying values, for example. Configuration may also include calibration, e.g., values used for translation of raw ADC data into physically measurable values. Configuration data usually remains constant. In terms of calibration, those parameters may change, caused by changes in the physical environment of the smart meter, e.g., a temperature rise or fall. In case parameters change, a changed parameter may be sent to the authority.

A configuration pointer can further be included in an array, which points inside the array and assigns, which of the randomly chosen configuration and/or calibration parameters is sent within this frame. The random sample array can be wrapped into a frame of the sending protocol which is used. The sending protocol can be, for example, Transmission Control Protocol/Internet Protocol (PCP/IP), Constrained Application Protocol (COAP), Global System for Mobile (GSM), Universal Mobile Telecommunication System (UMTS), ZigBee or any other communication protocol, preferably a protocol that is Open Systems Interconnection (OSI) layered.

The raw sample array and/or the protocol frame may be ciphered and/or signed (hashed) by a cryptographic algorithm. This algorithm bay be implemented in hardware (digital logic). The raw array or the frame can be sent via serial or any other communication interface into a network or communication channel CC, which has the authority 14 as a receiving endpoint.

This complete sequence of actions may be done as firmware code, ROM code or in hardware, in an atomic, thus not interruptible manner. Therefore, during this time no other application code is running on the metrology unit 12 of the metering device 1. The secure code may have exclusive access on the interface used for sending of data. There may not be any possibility to stop or interrupt this transmission of data, which may be done in an asynchronous manner.

It is not possible to tamper the raw data by removing arrays in the metering device or prevent them from being sent. Some protocols may require reception of a confirmation message. In case of wrongly received data, these messages can be resent. The confirmation reception could be handled by the standard protocol stack, for example. In case a message needs to be resent, the users protocol stack could resend an array, signed as invalid.

It is also not possible to tamper the raw data by adding “user friendly” test data arrays or blocks, because in this case the number of blocks received at the authority 14 would exceed the given rate of raw samples of 1%, for example. Receiving more than the given amount of raw data arrays could be seen as a tampering attack.

The authority 14 can recalculate the power and the root mean square value of the power, for example. Deviations of more than a given maximum threshold could be an indication for a tampering attack. There may be only one authority which receives both raw data and processed data. It would also be possible, that a first authority, the utility provider, for example, receives the processed data and a second authority, which is autonomous from the first authority, receives the raw data. The second authority may then check, if the billing is correct.

Spatially relative terms such as “under,” “below,” “lower,” “over,” “upper” and the like are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc. and are also not intended to be limiting. Like terms refer to like elements throughout the description.

As used herein, the terms “having,” “containing,” “including,” “comprising” and the like are open ended terms that indicate the presence of stated elements or features, but do not preclude additional elements or features. The articles “a,” “an” and “the” are intended to include the plural as well as the singular, unless the context clearly indicates otherwise.

Although present embodiments and its advantages have been described in detail, it should be understood that various changes, substitutions and alterations can be made herein without departing from the spirit and the scope of the invention as defined by the appended claims. With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A method of detecting tampering of data, the method comprising:
constant acquiring of measurement raw data in a sensor unit;
processing the measurement raw data of a defined time interval in a metrology unit, thereby obtaining first measurement results;
storing and/or transmitting the first measurement results to an authority at defined time instances via a communication channel;
storing and/or transmitting a defined fraction of the measurement raw data to the authority in a random manner via the communication channel;
processing the measurement raw data of the defined time interval at the authority, thereby obtaining second measurement results; and
comparing the first measurement results and second measurement results of a time interval.

2. The method according to claim 1, further comprising packing the measurement raw data to be stored or sent into an array.

3. The method according to claim 2, wherein each array comprises only one sample of each parameter of one measurement point or a subset of each parameter of one measurement point.

4. The method according to claim 2, wherein each array further comprises a code word that marks the array as a raw data array.

5. The method according to claim 2, wherein each array further comprises a randomly chosen internal configuration value of the metrology unit.

6. The method according to claim 5, wherein each array comprises a pointer that points inside the array to assign which randomly chosen internal configuration value is included in the array.

7. The method according to claim 1, wherein the defined fraction of measurement raw data is chosen depending on a random number.

8. The method according to claim 7, wherein the random number is provided by a true random number generator.

9. The method according to claim 1, wherein a deviation between the first and second measurement results of more than a defined maximum threshold is seen as a tampering attack.

10. The method according to claim 1, wherein receiving of more than the defined fraction of measurement raw data at the authority is seen as a tampering attack.

11. The method according to claim 1, wherein the measurement raw data or a random subset of the measurement raw data is stored into an intermediate, not changeable secure memory device and is sent to the authority from this memory.

12. The method according to claim 11, wherein measurement raw data is sent to the authority as not modifiable code or data.

13. The method according to claim 12, wherein measurement raw data is sent to the authority as ROM code.

14. The method according to claim 1, wherein the measurement raw data and the first measurement results are signed in a signature unit before being transmitted to the authority.

15. The method according to claim 14, wherein the signature unit is run in a privileged mode, when raw data is signed.

16. The method according to claim 1, wherein the measurement raw data is stored in a memory unit.

17. The method according to claim 16, wherein the stored measurement raw data can be read out of the memory unit via a serial communication channel.

18. A smart meter comprising:
a sensor unit, configured to measure one or more parameters of interest and provide measurement raw data that represents the parameters of interest; and
a metrology unit, configured to receive the measurement raw data from the sensor unit, to store and/or transmit a defined fraction of measurement raw data of a defined time interval in a random manner via a communication channel, to process the measurement raw data of the defined time interval to obtain first measurement results, and to store and/or transmit the first measurement results via the communication channel;
wherein the smart meter is configured to be coupled to an authority via the communication channel, the authority being configured to receive the first measurement results, receive and process the defined fraction of measurement raw data of the defined time interval thereby obtaining second measurement results, and to compare the first and second measurement results of a time interval.

19. A system to detect tampering of data, the system comprising:
a smart meter, which comprises
a sensor unit, configured to measure one or more parameters of interest and provide measurement raw data, representing the parameters of interest; and
a metrology unit, configured to receive the measurement raw data from the sensor unit, to store and/or transmit a defined fraction of measurement raw data of a defined time interval in a random manner via a communication channel, to process measurement raw data of the defined time interval thereby obtaining first measurement results, and to store and/or transmit the first measurement results via the communication channel; and
an authority coupled to the smart meter via the communication channel, the authority configured to receive and process the defined fraction of measurement raw data of the defined time interval thereby obtaining second measurement results, to receive the first measurement results, and to compare the first and second measurement results of a time interval.

20. The system according to claim 19, wherein the smart meter has a unique identification number to match the smart meter with an account of a customer.

21. The system according to claim 19, wherein the sensor unit is configured to measure parameters of interest of an electricity, water, gas or heating line.

22. The system according to claim 21, wherein the authority is controlled by an electricity, water, gas or heating supplier.

23. The system according to claim 21, wherein the authority is a central authority, independent of an electricity, water, gas or heating supplier.

24. The system according to claim 19, wherein the smart meter comprises a nonvolatile memory area, the nonvolatile memory area being readable only by the authority or after identification.

25. The system according to claim 24, wherein raw data, fractions of raw data or intermediate processing results are stored in the nonvolatile memory area.
